(19) United States
(12) Patent Application Publication
(10) Pub. No.: US 2004/0252376 A1
(43) Pub. Date: Dec. 16, 2004

(54) Beam converter for enhancing brightness of polarized light sources

(76) Inventors: Jacques Gollier, Painted Post, NY (US); Scott C. Pollard, Big Flats, NY (US)

Correspondence Address: CORNING INCORPORATED, SP-TI-3-1, CORNING, NY, 14831

(21) Appl. No.: 10/459,241

(22) Filed: Jun. 10, 2003

(51) Int. Cl. F21V 9/14; F21K 2/00; G02B 5/30; G02B 27/28

(52) U.S. Cl. 359/495; 359/352; 359/496; 362/19; 362/259

(57) ABSTRACT

A polarization rotator has an input surface for receiving a first collimated beam at a first incident angle and for receiving a second collimated beam at a second incident angle. An output surface exits the polarization rotation of one of the first and second beams. A halfwave retarder extends between the input and output surfaces. The halfwave retarder has a crystallographic axis orientation rotated 45 degrees from the plane of the input surface and a thickness suitable for responding to only one of the first and second incident collimated beams. The halfwave retarder rotates one of the first and second collimated beams producing relative phase difference such that the polarization vector is rotated 90 degrees and the optical paths of the collimated beams are unchanged.

### TECHNICAL FIELD

This invention relates to the field of devices for coupling light from light sources into waveguides, and more particularly to beam converters, beam shapers and polarization beam combiners.

### BACKGROUND

In various applications, light from several, such as two, semiconductor laser diodes are coupled into a single optical fiber, as a pump source or a signal source for an optical system. It is desirable for such light sources to have the capability of power scaling and/or of synthesizing a depolarized output. This combining or synthesizing capability is relevant to wavelength division multiplexing (WDM) applications where the laser diodes operate at different wavelengths and are modulated in response to different information signals, but couple into the same fiber as a signal source. In pump applications, the light from laser diodes is used to optically-pump rare-earth doped fiber or alternatively regular fiber, in a Raman pumping scheme. In such applications, using multiple emitters at the same wavelength coupled into one single fiber increases amplification. Despite such power and/or depolarization advantages, manufacturing and cost considerations of bulk optics still present technical challenges, such as coupling inefficiencies between the small pitches of dual-emitter diode lasers and the aligning optics.

The most common approach for making the polarization combination of the multiple emitters consists in using a lens array as the first optical element to collimate the beams and keep them spatially separated. By inserting a polarization component in one of the beams, it is possible to rotate the polarization vector of that beam with respect to the other one. Thus, the two beams have perpendicular polarization and can then be recombined by using conventional polarization beam splitters. However, the use of an array of lenses for the bulk optics is usually an expensive approach and makes the package design and alignment very complex. When considering the relatively small pitch between two emitters (in the range of 0.3 mm or less) of a dual-emitter laser diode, using the edge of a waveplate, as part of the bulk optics, may decrease waveplate transmissibility due to the imperfect surface quality of the waveplate from scratches, inclusions, and antireflective (AR) coating inhomogeneity.

In some other applications, the emitters are not single mode and are elongated in the horizontal direction. The optimization of the coupling optics consists usually in using anamorphic optics to transform the highly non symmetric emitted beam into an image that matches the near field and far field of the multimode output fiber.

Although such geometric optical solutions assure that more rays from the illumination source reach the waveguide entrances within their numerical apertures, the uneven distribution of radiant energy in the two orthogonal directions remains unchanged. The cost of anamorphic and other complex focusing optics is quite high.

Regardless of their complexity, the focusing systems are incapable of increasing the radiance of the light distribution imaged onto the waveguide entrances. The concentration of light within a less elongated spot shape would involve an increase in brightness. The Radiance Theorem forbids imaging systems to increase in the number of photons per solid angle per effective area of the beam (assuming the object and image spaces have the same index of refraction).

Therefore, there is a need to improve coupling efficiencies of multiple light sources without incurring the manufacturing complexities or costs of complex designs.

### SUMMARY OF INVENTION

The principle of the invention lies in using a wave plate to make a selective polarization rotation of the incident beams. The characteristics in term of thickness and crystallographic axis orientation of the plate are defined in such a way that the effect on the incident polarization vectors depends on the angle of incidence. So, when sending two collimated beams to the plate with different incidence angles, the plate rotates the polarization of one of the two beams allowing further polarization combination of the beams.

One beneficial application of this invention is when the two beams are coming from two separated emitters. The advantage of the configuration is that a spatial separation of the beams is not required so that this configuration is also suitable for dual emitters separated by very small pitches. At the limit, the configuration might also be applied in cases where there is no delimitation between the emitters which corresponds to the case of elongated multimode laser diode stripes.

Once the polarization of the incident beams has been modified, the beams are recombined by using conventional polarization beam splitters. Since the two beams segments are angularly distinguished, the most appropriate polarizer is a pair of Wollaston prisms. As one of the invention embodiments, one possible optical configuration consists in calculating the prisms in such a way that they also compensate for the beam ellipticity as with usual anamorphic prisms. The prism can then perform both functions of polarization combination and anamorphism compensation.

It is to be understood that both the foregoing general description and the following detailed description are merely exemplary of the invention, and are intended to provide an overview or framework for understanding the nature and character of the invention as it is claimed. The accompanying drawings are included to provide a further understanding of the invention, and are incorporated in and constitute a part of this specification. The drawings illustrate various embodiments of the invention, and together with the description serve to explain the principles and operation of the invention.

### BRIEF DESCRIPTION OF THE DRAWINGS

FIG. 1 is a diagram of an optical system including a beam converter for enhancing brightness of a linearly polarized beam, in accordance with the teachings of the present invention.

FIG. 2 is a diagram of the orthogonal polarization breakdown of the incident beams of unequal angles to the retarder 30 found in FIG. 1, in accordance with the teachings of the present invention.

FIG. 3 is a modified diagram of the optical system of FIG. 1 with a pair of Wollaston-anarmophic prisms substituted for the Wollaston integrated prism of FIG. 1, in accordance with the teachings of the present invention.

FIG. 4 is a diagram of the light source found in FIG. 3 but viewed from an orthogonal direction to depict compensation of ellipticity, in accordance with the teachings of the present invention.

### DETAILED DESCRIPTION OF THE DRAWINGS

Reference will now be made in detail to the present preferred embodiment of the invention, an example of which is illustrated in the accompanying drawings. Wherever possible, the same reference numbers will be used throughout the drawings to refer to the same or like parts.

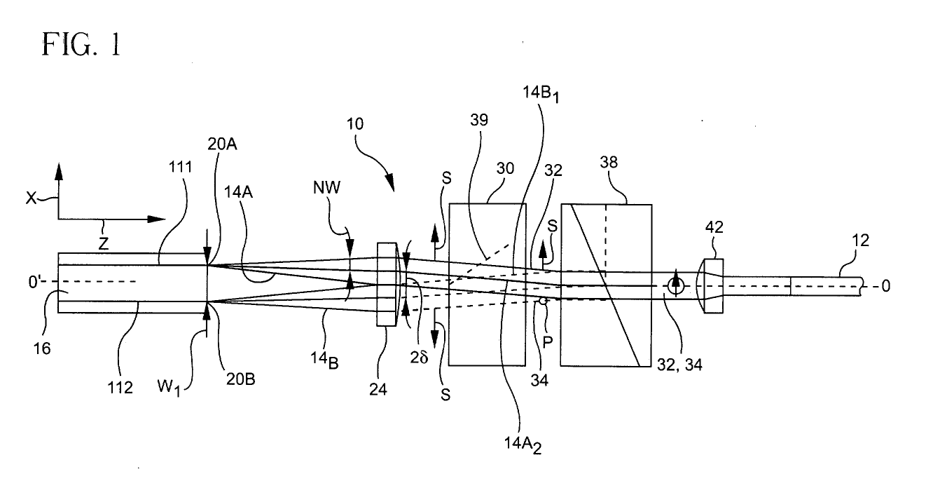

An optical package, assembly, or system 10 for optically coupling or optically pumping a waveguide 12 with a source beam 14_{A}, 14_{B} of linearly polarized light along the Y-axis is shown in FIG. 1. The waveguide 12 can be an optical fiber, such as a singlemode fiber, a polarization maintaining fiber, a multimode fiber, any combination of these types, or an optical device, such as a solid state or fiber laser, depending on the application desired.

A light source 16, such as a dual-emitter diode laser, emits from each of its waveguides 111, 112, a typically diverging beam 14_{A} or 14_{B} of linearly polarized light from one of the spot sources 20_{A} or 20_{B}. The size of the emitters 20_{A} and 20_{B} depend on the characteristic of the waveguide. Often, the source waveguide is single mode in the “Y” direction but can be multimode in the “X” direction. The two waveguides 111 and 112 are separated from each other by a pitch or width “W₁” on the order of about 0.3 mm or less. Each of the beams 14_{A}, 14_{B} have corresponding maximum exit angle dimensions “N_{H}” and “N_{W}” along two orthogonal axes “X”, “Y” normal to a direction “Z” of beam propagation. Each of the emitted beams 14_{A}, 14_{B} has an initial “S” polarization that extends along the “X” axis in the height or thickness dimension of the spot source 20.

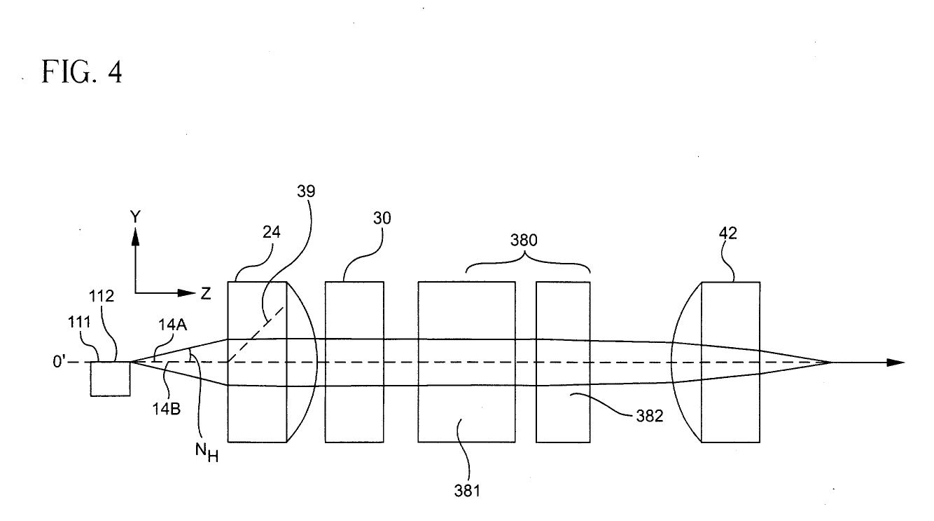

Because of the waveguide geometry, the exit angle dimension “N_{W}” in the Y direction is usually larger than the divergence “N_{H}” (similarly depicted in FIG. 4) by a factor of three or more. In conventional single mode emitters, the beam numerical apertures are in the range of 0.3×0.1 corresponding to beam diameters of 3 by 1 microns. In the case of multimode emitters, the beam divergences are more or less the same but the emitter size in the “X” direction is increased by up to 100 microns or more.

A collimator 24 is used to collimate the beams 14_{A} and 14_{B} emitted by the source 16. Because of the distance W1 between the emitters, the two collimated beams 14_{B1} and 14_{A2} are not parallel together and converge at a certain distance from the collimator 24. The angle between the two beams is a function of W1 and of the collimator focal length. The collimator 24 may have some different focal length in the X and Y directions to compensate for the ellipticity of the source and may also include some aspheric surfaces to minimize the spherical aberration.

A retarder 30, in the form of a half-wave plate is placed orthogonal to the optical path. This waveplate is calculated in such a way that the polarization vector for an incidence angle of beam 14_{A2} is not rotated while it is rotated for the incidence angle of the beam 14_{B1}. Thus, at the output of the waveplate, both beams have perpendicular polarization vectors. The waveplate is inserted in both beams so that a spatial separation of the beams is not required. This configuration is particularly advantageous for very small pitches.

A polarization beam splitter 38 which, in the case of FIG. 1, is represented by a pair of Wollaston prisms, is aligned at the convergence point of both beams. The beam splitter is used to recombine the two angularly separated beams into one single collimated beam. An imaging lens 42 images the beam onto the output waveguide 12. The imaging lens 42 can also present a different focal length in the “X” and “Y” direction in such a way that the geometrical characteristics of the imaged beam are the same as the characteristics of the output waveguide 12.

One possible way to get the mode matching of the imaged beam consists in using the same lenses for the collimation (24) and for the imaging functions (42) so that a 1:1 magnification can be obtained between the input and the output. A lensed fiber is then used as the output waveguide 12 which is the same fiber that is commonly used to make direct diode to single mode fiber butt coupling.

The waveplate or retarder 30 is preferably a quartz (/2 crystal plate used to rotate the polarization vector of an incident beam. However, the way that the waveplate 30 is conventionally used is such that the crystallographic axis 30 is perpendicular to the incident light. This, indeed, is the configuration that minimizes the effect of the incidence angle on the polarization rotation. Usually, very thin so called zero order plates are used which minimize both the dependence on the angle and on the wavelength of the source.

According to the teachings of the present invention, the angle of the crystallographic axis 39 and the thickness of the plate 30 are calculated to generate the preferential polarization rotation of one beam. This makes the design of the waveplate 30 very unusual while providing polarization conversion efficiencies up to 95%. Although a dual-stripe pumping application is shown, the present invention relates more generally to a method of making a selective rotation of the polarization vector of beams. The present invention of such an angularly sensitive waveplate can be used in any multibeam configuration, whether dual-stripe or any other array of multiple beams, whenever there is a need to rotate selectively some of the beams.

The core idea of the angular sensitive waveplate 30 is to use beams that are angularly separated instead of being spatially separated and in using a birefringent material that is making a different polarization rotation versus the angle of incidence. In the example of FIG. 1, the birefringent plate or retarder 30 is designed, software modeled, or otherwise calculated in such a way that the polarization is rotated by 90 degrees for one of the two incidence angles and is kept unchanged for the other incidence angle.

The waveplate works like a conventional quartz half waveplate to make a 90 degree polarization rotation, the ordinary and extraordinary axis of the plate being at 45 degrees with respect to the incident polarization vector. However, by providing the crystal axis 39 at an angle that is not perpendicular with respect to the optical axis z, the retardation angle becomes very sensitive to the incidence angle. The waveplate thickness is then calculated in such a way that the polarization is rotated for one incident beam and is not rotated for the other beam at the other incidence angle.

In general, a conventional waveplate rotates the polarization vector by orienting the ordinary and extraordinary axes of the birefringent plate at 45 degrees with respect to the incident polarization vector. The incident beam is decomposed along the two axes of the crystal. When the incident beam is perpendicular to the crystal axes, as in a conventional orientation, the two polarization vectors are propagating at different speeds corresponding respectively to the ordinary and extraordinary indices of the birefringent material. The thickness of the crystal is then calculated in such a way that the difference of phase between the two polarization components at the output of the plate corresponds to one half of the wave. The principle is that the incident polarization is being decomposed along the ordinary and extraordinary axes of the crystal. In other words, the difference of propagation speed generates then a difference of phase that is making a 90 degree polarization rotation when the difference of phase is half a wave.

The angular sensitivity of such a conventional waveplate is a well known effect and is generated by two different factors that are cosine functions of the incidence angle such that the incident angle is usually too small a factor to have any significant effect. First, the optical path length, or thickness, inside the crystal increases with the incidence angle. Second, the index along the extraordinary axis is a function of the incidence angle and is represented by an ellipse of index.

By cutting the crystalline quartz to provide the desired crystallographic axis direction, it is then possible to adjust the two refraction indexes n₁ and n₂ seen by the two incident beams and generate a difference of phase and polarization rotation. In the specific application of a dual-stripe 980 nm pump application, the thickness and crystal orientation are adjusted in such a way that one polarization is rotated by 90 degrees while the other one is not rotated. The present invention adjusts the angular orientation of the crystal to introduce a non symmetric effect that will impact the two incident beams in a different way.

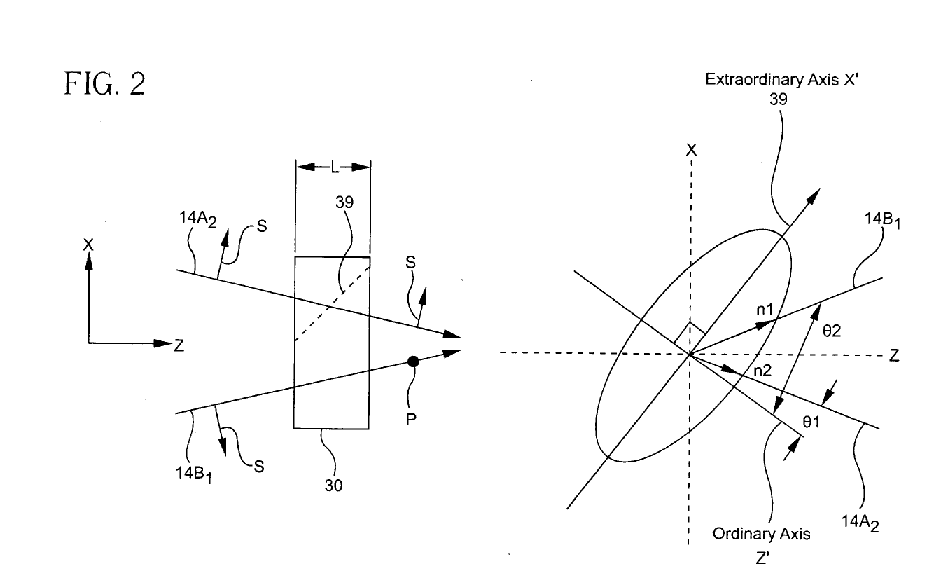

Accordingly, the incident beams are purposely angularly separated to be not perpendicular to the crystal axis 39 and not parallel to the optical axis Z. In other words, the incident beams have unequal incident angles with respect to the crystal axis 39. To generate the selective polarization rotation indicated in FIG. 1, the orientation of the crystal with respect to the incidence angles of the two beams is adjusted as shown in FIG. 2.

Since the incident beams are no longer perpendicular to the crystal axis, the extraordinary index of the crystal has to be replaced by an index which is a function of the angle between the incident beam propagating into the crystal and the crystal axis itself.

(1/n( )²=((sin(( )/nₒ)²+(cos( )/nₑ)²) (Eq. 1.1)

Where

(is the angle between the incident beam and the crystal axis;

nₒ is the ordinary index of refraction for the ordinary polarization component of the beam; and

nₑ is the extraordinary index refraction for the extraordinary polarization component of the beam.

At low angles, the index given by equation 1.1 is equal to the extraordinary index for conventional waveplates whose axis is perpendicular to the optical axis Z and the incidence angles remain relatively low.

Now with different sufficiently large angles (1 and (2, different propagation speeds for the extraordinary polarization components of the two beams also have to be substituted into equation 1.1 to provide the following modified equations:

(1/n1)²=(⁻(sin(( )/n(ₒ)²+(cos( )/n(ₑ)²) (1.2)

(1/n2)²=((sin((₂)/nₒ)²+(cos((₂)/nₑ)²) (1.3)

Referring to FIGS. 1 and 2, the exemplary polarizing crystal of the retarder 30 thus has an optical axis 39 inclined to the direction of beam propagation of the first subbeam 14_{B1} through an angle of 2(+(1=(2. Similarly, the exemplary polarizing crystal of the retarder 30 has an optical axis 39 inclined to the direction of beam propagation of the second subbeam 14_{A2} through an angle of (2−2(=(1. The thickness dimension “L” between the two surfaces of the retarder or path length of the crystal required to polarization rotate only one of the two beam segments 32 and 34 is given by the following equations:

L=(m×( )/(n1−n₀) (1.4)

L=[(m+1/2)×(]/(n2−n₀) (1.5)

Where

n1 is the extraordinary index of beam 1 (from equation 1.2);

n2 is the extraordinary index of beam 2 (from equation 1.3);

L is the thickness of the crystal; and

m is an integer number.

By applying those equations to a specific application of a dual-stripe laser pumping at 980 nm and assuming quartz as the material for the waveplate, the polarization rotator 30 has a thickness of around 0.8 mm or more specifically 0.837 mm and the incidence angles of the beams arearound +/−5 degrees in air or more specifically +/−4.85 degrees, with the axis of the birefringent plate being set at 45 degrees with respect to the optical axis “Z”.

The same equations can also be applied when both laser emitters have different wavelengths. As an example, the same waveplate as defined before can be used to combine emitters at 980 nm and 1430 nm, the incidence angles of the beams being set respectively to −4.85 and zero degrees. In the specific case where the two wavelengths are significantly different such as 980 nm and 1430 nm, it is also possible to find a solution were both beams are parallel, the incidence angle being then set to zero.

By using a polarizing beamsplitter 38, such as a Wollaston prism, for instance, the two orthogonal polarizations can be recombined into one single unpolarized beam. Other types of polarization components, such as a polarization-sensitive beam rotator, can be used as the beamsplitter 38.

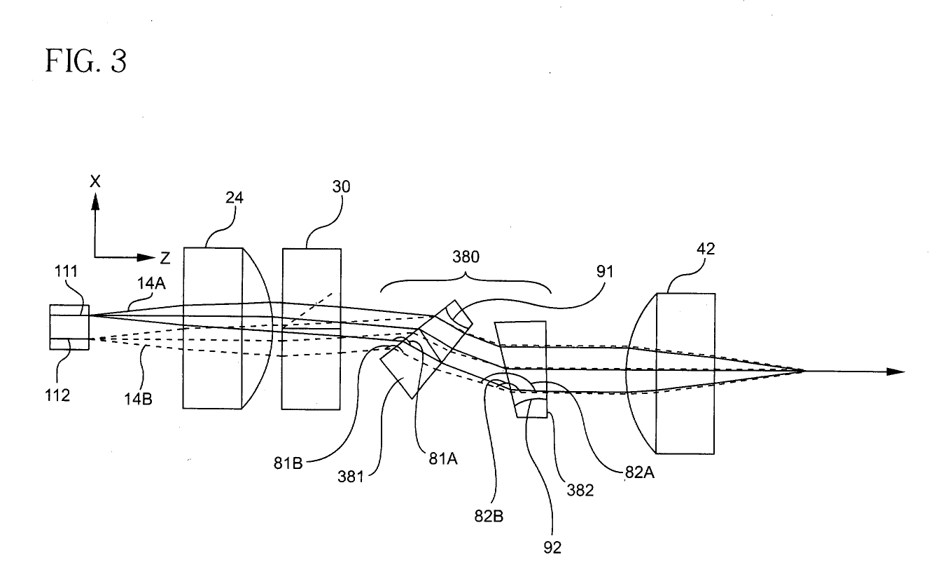

Referring to FIGS. 3-4, a particular arrangement of the Wollaston prisms is shown where the two prisms are defined in such a way that they simultaneously provide the polarization combination and the beam ellipticity compensation. The two prisms of FIGS. 3-4 are made of a birefringent material with high birefringence such as Ytrium Vanadate or calcite. Because of their birefringence, the deviation angle of each of the prisms depends on the direction of the polarization vector so that the two converging beams can be recombined into one single collimated beam. The two prisms are also aligned in order to provide some beam magnification in the “X” axis direction as with conventional anamorphic prisms. This technique allows the compensation for the ellipticity of the emitting source without requiring any additional optical component.

Conventional anamorphic prisms are commonly used for ellipticity compensation and can be bought off-the-shelf, as can conventionally-bought Wollaston prisms. Wollaston prisms and Anamorphic prisms are both very common optical components. For example, Wollaston prisms are available from Melles Griot as product model number 03PPW001. Anamorphic prisms are also available from Melles Griot as product model number 06GPA001. However, combining both functions of anamorphism and polarization combination is unusual.

Referring to FIG. 3, an illustration of the result of optical modeling is shown. The subprisms 381 and 382 provide both beam combination and beam enlargement in that view (and keep the beam unchanged in the other view of FIG. 4). To provide for beam ellipticity compensation, optical modeling software can be used to calculate the required dimensions of the Wollaston prism 380, made-up of the two subprisms 381 and 382 in such a way that the Wollaston prism 380 does the polarization combination and also compensates for laser diode beam ellipticity. One such modeling result is shown which is an example where the wedge angle 91, 92 and orientations of the Wollaston subprisms 381 and 382 have been calculated to compensate an ellipticity factor of around 2:1

The exemplary optical system is calculated, modeled, and shown in two different directions in FIGS. 3 and 4. In the direction of the diode fast axis corresponding to the “Y” axis of the drawing of FIG. 4, the input lens or collimator 24 and the output lens or imaging optics 42 are defined in such a way that the image of the diode emitter or spot sources 20A, 20B of FIG. 1, matches the mode of the output fiber 12. On the other hand, in the direction of the slow axis of the diode corresponding to the “X” axis of the drawing of FIG. 3, the deviation angles 81A, 81B, and 82A, 82B and of the Wollaston subprisms 381, 382, respectively, are set to recombine the two polarizations, and introduce a magnification that is equal to the diode beam ellipticity. To find the best configuration, a system of three equations has to be solved. First, the polarization differential deviation induced by both prisms has to be equal to the angle between the incident beams (eq. 1). Second, the beam magnification has to be equal to the ellipticity that is needed for compensation (eq. 2). Third for packaging ease, the output beam has to be parallel to the optical axis of the package (eq. 3). The, three degrees of freedom are then the angles of both prisms and their mutual orientation.

It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents.

I claim:

1. A polarization rotator, comprising;
an input surface for receiving a first collimated beam at a first incident angle from a first emitter and for receiving a second collimated beam at a second incident angle from a second emitter;
an output surface for exiting the polarization rotation of one of the first and second beams; and
a halfwave retarder extending between the input and output surfaces, the halfwave retarder having a crystallographic axis orientation rotated a sufficiently large angle from the plane of the input surface for providing a selective polarization rotation depending on the angle of incidence, and a thickness suitable for responding to only one of the first and second incident collimated beams, the halfwave retarder rotating one of the first and second collimated beams producing relative phase difference such that the polarization vector is rotated 90 degrees and the optical paths of the collimated beams are unchanged.

2. The polarization rotator of claim 1 wherein the sufficiently large angle is approximately 45 degrees.

3. The polarization rotator of claim 2 wherein the first frequency is about 980 nm, the second frequency is about 1430 nm, the first incident angle is about −4.85 degrees and the second incident angle is about zero degrees.

4. The polarization rotator of claim 2 wherein the first and second incident angles are equal angles and where the wavelengths of the two emitters are at different wavelengths.

5. The polarization rotator of claim 1 wherein the first and second incident angles are symmetrically equal converging angles and where the wavelengths of the two emitters are identical.

6. The polarization rotator of claim 2 wherein the first and second incident angles are symmetrical about plus or minus 5 degrees.

7. The polarization rotator of claim 1 wherein the first collimated beam is at a first frequency and the second collimated beam is at a second frequency, wherein the first and second incident angles are unequal and the first and second frequency are equal.

8. The polarization rotator of claim 7, wherein the first and second frequency is about 980 nm.

9. The polarization rotator of claim 1 wherein the halfwave retarder is a crystalline quartz waveplate cut to provide the crystallographic axis orientation and having an extraordinary index as a function of the incident angle and the crystallographic axis.

10. The polarization rotator of claim 1, further comprising a multimode stripe diode laser for providing the light source of the first and second collimated beams.

11. A beam converter comprising:
an optical pathway along which a linearly polarized beam having an initial transverse area propagates;
a polarization rotator in the path of a first transverse segment and a second transverse segment of the beam, whereby the polarity of the first transverse segment of the beam will be rotated with respect to the polarity of a second transverse segment of the beam; and
a polarization-sensitive beam rotator in the path of at least portions of the first and second transverse segments of the beam so as to combine the portions within a common transverse area.

12. The beam converter of claim 11 in which the polarization rotator is capable of changing polarity of the first transverse segment of the beam to a linear polarization that is orthogonal to the linear polarization of the second transverse segment of the beam.

13. The beam converter of claim 11 in which the polarization rotator is a halfwave retarder having a crystallographic axis orientation rotated 45 degrees from the plane of the input surface and a thickness suitable for responding to only one of the first and second transverse segment of the beam, the halfwave retarder rotating one of the first and second transverse segments producing relative phase difference such that the polarization vector is rotated 90 degrees and the optical paths of the transverse segments are unchanged, and the retarder is placed orthogonally to the optical pathway.

14. The beam converter of claim 13 wherein, the polarization-sensitive beam rotator, comprises a pair of prisms that are calculated in such a way that the polarization combination of the beams and compensation for the ellipticity of the beams are provided whereby the function of wollastone prisms and of anamorphic prisms is then performed by the polarization-sensitive beam rotator.

15. The beam converter of claim 13, wherein the halfwave retarder comprises an angularly sensitive waveplate.

16. The beam converter of claim 11 further comprising a collimator located in advance of the polarization rotator along the optical pathway.
